(19) United States
(12) Patent Application Publication
(10) Pub. No.: US 2009/0222835 A1
(43) Pub. Date: Sep. 3, 2009

(54) Operating System for a Chip Card Comprising a Multi-Tasking Kernel

(75) Inventors: Wolfgang Effing, Forstern (DE); Stephan Spitz, München (DE); Erich Englbrecht, München (DE); Robert Hockauf, München (DE)

Correspondence Address: BACON & THOMAS, PLLC, 625 SLATERS LANE, FOURTH FLOOR, ALEXANDRIA, VA, 22314-1176, US

(73) Assignee: GIESECKE & DEVRIENT GMBH, München (DE)

(21) Appl. No.: 12/224,295

(22) PCT Filed: Feb. 21, 2007
(86) PCT No.: PCT/EP2007/001511

§ 371 Date: Jan. 12, 2009

(30) Foreign Application Priority Data
Feb. 22, 2006 (DE) 10 2006 008 248.6

(51) Int. Cl. G06F 9/50; G06K 19/06

(52) U.S. Cl. 718/104; 235/492

(57) ABSTRACT

The invention relates to a method for operating a chip card (C), a microprocessor for being inserted into the chip card (C) and a computer program product, as well as a method for manufacturing and/or for maintaining a chip card (C) which is operated with the help of a method described above. Here central multi-tasking kernel (MTK) is provided, which controls the entire operation of the chip card (C), so that there can be activated a plurality of application programs (A) on the chip card (C) at the same time, an application program (A) also being able to realize security technical functions for the chip card (C).

The invention relates to the field of chip card technology and in particular to a method and a system for operating mobile data carriers.

Today mobile data carriers are used in varied application areas, among other things as a chip card, such as e.g. the electronic cash card, the application as an entrance control or access control, chip cards in health care, in the area of the mobile radio technology as a SIM card (subscriber identity modules). The SIM card is an identification card of the size of a check card for subscribers of a mobile radio service and is also referred to as a “smart card”. Moreover, there is a multiplicity of further possibilities for the application of chip cards, for instance in the area of navigation technology, with digital dictation systems or digital camera systems etc.

Usually, the mobile data carrier, in particular the chip card, comprises the following hardware resources: a microprocessor or a CPU (central processing unit) for data processing, a plurality of data memories of different type, such as the RAM (random access memory), the ROM (read only memory) and the EEPROM (electrical erasable read only memory) and interfaces for a data exchange between the various components, in particular between the microprocessor and the data memories and, if any, to further modules on the chip card, as well as to further external modules, which are provided outside the chip card and are to be in a data exchange with the chip card. These can be e.g. reading devices or more complex back-office systems.

Depending on the field of application it is possible to run one or a plurality of application programs on the chip card. In this case, i.e. when a plurality of applications are to be handled on one chip card, the security aspect becomes more and more important. Because it has to be ensured, that an unauthorized data access can be reliably prevented. In case of a plurality of application programs on one card the risk rises in so far as in data-technical terms the applications must be reliably decoupled and separated from each other. E.g. there must be guaranteed, that an unauthorized access to a certain memory area cannot be handled via a different, foreign application program.

Therefore, cards on which a plurality of application program can be handled require an increased need for security and are more complex; they require more extensive mechanisms for operating the card.

Operating the chip card as such and the handling of programs or application programs running thereon are part of the working area of the operating system. With that the operating system in a way is an interface between the actual application software and the underlying hardware of the chip card. Usually, the today command-triggered chip card operating systems are based on the ISO-7816 standard known in the prior art. In this standard it is provided that all functions or instructions of the operating system and the application programs are triggered by commands, which are received via an external interface. Here, the instructions are executed only sequentially, which means one after the other. In other words, with that there is only one control flow for processes in the respective programs. Current implementations on chip cards thus only consist of processes with one single execution path or with one single thread. Operating systems, which support a multi-threading, i.e. a plurality of execution paths, have not been known for chip cards until now. But this is a serious disadvantage, which distinctly restricts the flexibility when using and operating chip cards.

So as to counteract the disadvantage of low flexibility, in the prior art there is provided that for the operating systems of chip cards of the new generation the program code can be reloaded at any desired points of time. With that it becomes possible to exchange individual modules or components of the chip card for others even after the card has been issued. Relevant methods for loading application programs via an interface conforming with ISO-7816, e.g. are described in the standard “Global Platform Standard, Global Platform Card Specification V2.1.1”.

Operating systems, which permit the reload of program code, in principle can be subdivided into two categories:
operating systems, wherein it is provided to load a compiled code already translated by a compiler into the respective files of the chip card. But this approach involves a high security risk, since with microcontrollers which work without a memory management unit (abbreviation MMU) in principle it is possible that a reloaded program code can also access foreign memory areas of other applications.
operating systems which are based on the fact that program code to be reloaded is interpreted on the chip card. Here the interpreter checks during the program execution, which memory areas are addressed and with that can ensure that unauthorized accesses to foreign applications are not executed. Some of the well-known solutions of this approach are the Java card specification (Java card standard, Java Virtual Machine, Javasoft, JCS) and the C interpreter MEL (MEL stands for Multos Executable Language) from Multos. The basic disadvantage of this second approach is that interpreters in principle work slow and this can lead to a poor performance.

Microcontrollers for chip cards that are on the today's market normally are provided with processors which do not have any memory protection mechanisms or other monitoring possibilities against unauthorized accesses. So as to counter this security risk, the reloaded program code is not directly executed, but only indirectly, e.g. via a so-called virtual machine, which again interprets individual program instructions (i.e. the byte code) in platform-dependent program code, so that address areas of individual programs or application programs are separated via the virtual machine or via the interpreter. In the virtual machine is defined, which accesses are authorized, or to which data an application program has access. But one important disadvantage is that in principle only interpreter code can be reloaded. Platform-dependent program code, e.g. drivers for input/output interfaces cannot be loaded any more once the card has been issued.

A further disadvantage is that the security of the memory protection is based on the security of the virtual machine or on the interpreter. It is possible to provide a so-called byte code verifier which appropriately checks the byte code, but it is disadvantageous that the required checks of the verifier are carried out mainly outside the chip card which is due to resources and/or performance reasons. But when the checks of the byte code-verifier are carried out outside the chip card, the byte code-verifier is open to attacks.

Moreover, there lies a further disadvantage in the known solution, that cannot be ignored in practice, namely the smaller scope of memory protection. The memory protection in previous chip card operating systems in this approach is based exclusively on the interpreter or on the virtual machine. A memory protection for more extensive and complex systems, which e.g. consist of a plurality of virtual machines, is not known. In other words, there are no solutions for chip card operating systems with a memory protection during the data exchange between a plurality of interpreters or a plurality of virtual machines on one chip card.

Therefore it is the problem of the present invention to show a way with which a distinctly improved memory protection for chip card operating systems can be achieved and which permits a more flexible use of chip cards. Moreover, there shall be provided an operating system for chip cards capable of multi-tasking or a respective chip card and a respective microprocessor.

This problem is solved with a method for operating a mobile data carrier, with a mobile data carrier, a microprocessor, a computer program product and with a method for manufacturing and for maintaining a mobile data carrier according to the accompanying independent patent claims.

The problem in particular is solved by a method for operating a mobile data carrier, which is provided with the following resources:
at least one microprocessor,
at least one data memory, which usually consists of a plurality of different data memory areas and
interfaces for a data exchange between microprocessor and data memory and/or further modules, which are associated to the mobile data carrier, there being the possibility that on the mobile data carrier can be executed different application programs by the mobile data carrier comprising a central control unit which controls and/or monitors the operation of the mobile data carrier, in particular the execution of the application programs, in such a way that a plurality of application programs can be active at the same time by allocating or taking away resources to or from each application program at a time according to a configurable scheduling mechanism and/ or the data exchange being controlled.

The mobile data carrier usually is a chip card or a SIM card or any other microprocessor card, which can be inserted into a terminal, such as into a mobile terminal, such as a cell phone.

The invention can be used in different fields. For example, the mobile data carrier according to the invention can be used in navigation systems, PDAs, digital dictation systems, digital cameras or telephone sets. But the main embodiment of the invention relates to a chip card and in so far the term chip card is considered the main example for an embodiment of a mobile data carrier.

A chip card normally comprises the following hardware resources: a microprocessor for data processing, data memories and interfaces. But in alternative embodiments it is also possible to provide further resources, such as e.g. a mathematical coprocessor.

The interfaces normally are input/output interfaces. Here, too, there can be provided further interfaces, for instance to other external and/or internal modules, that are associated to the mobile data carrier.

Crucial point of the method according to the invention for operating the chip card is the central control unit, which in the preferred embodiment is formed as a multi-tasking kernel and a component of an—existing or new—operating system for the chip card. The central multi-tasking kernel controls and/or checks processes on the chip card and provides protected areas for the execution.

In contrast to operating systems known from prior art, wherein the instructions of the operating system or the application programs are triggered by commands, which are received via the external interface, and are executed sequentially one after the other, according to the invention all instructions are controlled by the multi-tasking kernel. The multi-tasking kernel controls the operation of the chip card and the handling of the processes running on it in such a way that a plurality of application programs can be executed at the same time on one chip card. This is achieved by the multi-tasking kernel working according to a scheduling mechanism, which preferably is configurable. The scheduling mechanism permits—in view of the entirety of all activatable or activated application programs on the mobile data carrier—an optimized execution or an optimized operation of the data carrier.

The multi-tasking kernel permits a virtually parallel execution of a plurality of software-based application programs executable on the chip card. It synchronizes the access to common resources with the help of the scheduling mechanism. Furthermore, it provides mechanisms for the access protection, which protect from an unauthorized access to data and which serve for the protection against impairments of the sequence of operations. This is achieved by the multi-tasking kernel allocating to the application programs appropriate quotas of computation time and resources according to the configurable scheduling mechanism. I.e. according to the invention the handling or execution of instructions is triggered exclusively by the central multi-tasking kernel.

Thus the multi-tasking kernel offers the possibility that different application programs or different applications are carried out virtually at the same time, in particular with the option that resources (such as certain memory areas in the RAM or in the nonvolatile memory, interfaces or input/output channels, cryptological modules etc) are exclusively allocated to an application program and if required again taken away from them. With that in the interaction with a chip card terminal an application program can execute e.g. a “classical” chip card legacy task (e.g. credit/debit instructions), while another application is executed in the background. By using the multi-tasking kernel a—one-way or mutual—influence of active applications can be reliably prevented, which in an advantageous way increases the security of the whole system.

Each service or each application program is provided with a protected address space. It is also possible, that a plurality of application programs are combined with respect to the memory management, so that they are integrated in a joint address space. Advantageously, according to the invention a secured data exchange between all involved modules of the chip card can be permitted. In particular, the data exchange between the individual, different application programs is completely secured by the multi-tasking kernel, likewise the data exchange with other modules which possibly are connected to the chip card via respective interfaces, which altogether distinctly increases the security of the whole system.

According to the invention the functionality of the respective application programs or services is not restricted. Services located in a protected address space even can simulate the complete functionality of a previously conventional chip card operating system (e.g. electronic cash card, entrance control, SIM card, health card etc) in an environment which is protected from other services. The protective mechanism according to the invention can completely cut off the application programs from each other, so that a plurality of virtual chip cards can securely coexist on one hardware platform.

In other words, with the solution according to the invention with the multi-tasking kernel it is possible to provide a plurality of “virtual” chip cards in areas strictly separated from each other on one hardware platform, in particular on one chip card. The individual application programs, which each realize “virtual chip cards”, are no longer configured around the command interface—such as with classical operating systems known from prior art—, but are controlled as services via the functions of the central multi-tasking kernel.

A further crucial aspect of the present invention is the memory protection. According to the invention in the multi-tasking kernel is realized a memory protection for platform-dependent program code. With that the above-mentioned disadvantages of the interpreter-based memory protection of the operating systems known from the prior art can be overcome.

In an advantageous development of the invention the multi-tasking kernel accesses a mechanism for supporting the separation of the address spaces, in particular a memory management unit (abbreviation: MMU) and/or a memory protection unit (abbreviation: MPU). An advantage of this mechanism is that a distinctly improved security situation can be achieved, compared to a mere software-based interpreter or a virtual machine known from the prior art.

By using the multi-tasking kernel at a central point, which means on the hierarchically highest priority level, a plurality of application programs active at the same time can be executed on one chip card. With that the possibility is opened that individual application programs can have access in parallel and with that at the same time to not-conflicting resources, and e.g. can exchange data via possibly different input/output interfaces with external or internal systems. Cumulatively or alternatively, data can also be processed, in particular prepared, in the background by an application program without this being explicitly triggered via an external communication.

The multi-tasking kernel provides, that priorities, in particular with respect to individual application programs or application groups, can be granted and that a computation time check is effected. By monitoring the priorities and the computation time the multi-tasking kernel can ensure, that the computation time or execution time provided for an application program is limited and that the limitations predetermined by the multi-tasking kernel are not manipulated. A limitation of the computation time is achieved in that the consumption of the computation time is checked by the multi-tasking kernel and the computation time is decidedly allocated to the application programs in the form of time quanta. The manipulation-proofness is achieved in that exclusively the multi-tasking kernel runs in a higher privileged operation mode, while all application programs run in an application mode arranged hierarchically lower.

But besides the synchronization of active processes the multi-tasking kernel has still further tasks. According to the invention it likewise serves for the management of the resources of the chip card (such as memories and interfaces). The resources can be requested by the application program on the first loading or dynamically to the runtime from the multi-tasking kernel. The multi-tasking kernel decides alone and at first instance, whether the resources are exclusively allocated to an application program or not. In the next instance the application program can pass on rights to further sub-application programs, which are smaller or equal to the rights which have been granted to it before by the multi-tasking kernel. Thus a sub-granting or a passing on of rights to subordinated sub-application programs is also provided.

Furthermore, the multi-tasking kernel serves to provide mechanisms for the secure data exchange between the individual application programs. The data exchange between the application programs controlled and/or monitored by the multi-tasking kernel basically is founded on the principle, that the data exchange exclusively is effected under the control of the multi-tasking kernel. For this in principle two alternatives are provided:
1. The involved application programs are in a data exchange or can exchange respective messages via special multi-tasking kernel function callings.
2. The involved application programs can exchange data via pre-defined memory areas, which are provided to a plurality of—in this case active—application programs.

In principle it is provided, that each application program decides itself, whether and which data it provides to other application programs. I.e. with the solution according to the invention the advantage is achieved, that different applications can be integrated on a chip card, but are securely separated from each other.

A substantial advantage of the solution according to the invention is furthermore that the basic advantage of flexibility, which inter alia can also be achieved in the prior art with the approach of reloadable program code, can also be maintained and even distinctly improved with the solution according to the invention. In principle, even after the card has been issued, it is possible to exchange components, in particular system components, in the chip card operating system or to add new components, such as updates, or components which serve for bug-fixing (error recovery) or the like.

In the preferred embodiment of the invention it is provided, that, in principle, hardware-oriented system components—as mentioned above—in the chip card operating system, which are not implemented via an interpreter-based programming language, such as crypto-routines, drivers for input/output interfaces etc, can be replaced after the card has been issued. Such replacement is effected without any unintended and/or damaging influences being exerted on other components, because the memory protection of the multi-tasking kernel prevents an influence on other components or operating system components exerted through the replaced service. In an advantageous development of the invention, however, it is possible to apply this approach not only to operating system components, but also to other components of the chip card system, which then can be replaced even after the card has been issued, when the respective application allows this without causing further errors. With that the system based on the mobile data carrier can be used very flexible and is easy to change.

A further advantage of the solution according to the invention is that the possibilities of data transfer with respect to the mobile data carriers can be extended. Through the controlling by the multi-tasking kernel it becomes possible that necessary communication processes are triggered in an optimized way, that a parallel or simultaneous communication with internal or external modules via a plurality of equal or different hardware interfaces is effected. In other words, a chip card system based on the multi-tasking kernel according to the invention can use the virtually parallel execution of program code for exchanging data via different input/output interfaces at the same time, e.g. via a contactless interface according to the ISO 14443 standard or according to the NFC standard (near field communication) and in parallel via a contact-type interface according to the ISO7816 standard. With that the entire hardware resources of the mobile data carrier can be used distinctly better, which altogether leads to an increased processing speed of the data carrier.

Normally two operation modes are provided for the operation of the mobile data carrier: A privileged mode, in which the central multi-tasking kernel runs, to which more extensive rights are granted than to a second mode, in which in principle all applications and/or processes or application programs run. Depending on the use of the mobile data carrier it is also possible to provide still further privilege levels. But in each case it is necessary that the central multi-tasking kernel has the highest privilege, so that a central controlling of the entire operation of the data carrier is permitted.

In principle, the multi-tasking kernel according to the invention is based on a scheduling mechanism, which is adapted, in view of the entirety of all processes running on the data carrier (comprising operating system processes and application processes) to manage an optimized execution or handling of all processes.

In a preferred development of the invention it is provided, that the scheduling mechanism accesses an optimization algorithm, which optimizes the operation of the data carrier regarding one or a plurality of the following optimization criteria:
an optimization regarding time, in particular concerning a processing speed, concerning a dwell time of processes in the main memory and/or a response time of the processes;
an optimization regarding the system-resources, in particular hardware resources;
an optimization regarding memory space requirement and
an optimization regarding the required data transfer.

In alternative embodiments further optimization criteria are configurable. This has the advantage, that the solution according to the invention is very flexible regarding the basic process handling. Thus the operating system of the chip card is not limited to a certain optimization criterion. Usually, the configurable mechanism is set on the basis of pre-defined input parameter. The input parameter can be read in via respective interfaces. Alternatively, it is possible, that for certain applications a preferred processing of the respective application program takes place. Then the multi-tasking kernel can exclusively allocate all or selected resources to a certain application program. The formation of this feature, however, is not necessary and merely optional according to the invention.

In alternative embodiments it is also possible to provide other algorithms for scheduling the processes for operating the data carrier. E.g. it is possible to form the scheduling-method on a throughput basis and/or a utilization basis.

To be able to realize the task of the scheduling-method it is necessary, that the multi-tasking kernel automatically captures and checks the execution time for each process. Furthermore, a limitation for the execution time of each process is predetermined (this is effected according to the mechanism: “Which process is allowed to last how long?”). As a result it is possible, that the scheduling mechanism automatically limits the execution time for a respective application program by checking the consumption of computation time and by monitoring the observance of the limitations. Optionally, processes can also be executed in a nested or interlaced fashion, so that altogether the execution time of all required processes can be optimized on the data carrier. According to the optimized scheduling method the computation time is allocated to the respective process or to the respective application program.

Within the framework of the scheduling it is possible, that to individual application programs and/or individual processes priorities are allocated, which are taken into consideration when scheduling. Moreover, it is possible, that a process hands down its priority to sub-ordinated sub processes.

In this context reference is made to a further substantial aspect of the solution according to the invention regarding an improved security approach. As already mentioned above, chip cards can also be used in terminals, such as in mobile phones and in this case are formed as a SIM card. In such case of application, usually, there are provided still further interfaces at the SIM contacts in the mobile phone, such as USB or MMC interfaces, via which further security devices can be addressed, e.g. SecureMMC cards etc. When chip cards are used in mobile phones or other mobile terminals, it is often the case that security modules or security components, which are to perform security checks, are formed in a manner distributed in the system. Such distribution of security-critical functions to different systems and components in the chip-card-related components or devices leads to a plurality of disadvantages. On the one hand the manufacturing costs are increased, because a plurality of hardware elements must be used, and on the other hand the overall error-proneness of the system is distinctly increased, because by the multiplicity of modules there is an increased proneness to security leaks. Moreover, because of the previous realization of security-relevant functions in a distributed fashion it is necessary to transfer data to a great extent. This again leads to a security leak, because in principle every data transfer inheres a security risk. But with the operating system according to the invention able to multi-tasking it becomes possible, that the chip card, which is operated with this system, can assume more functions, inter alia, besides the classical standardized functions (in the above example besides the pure SIM functionality) still further security-technical functions. On the other hand with this approach it becomes possible to integrate all security functions in a central fashion at one place in the system.

In a preferred embodiment of the invention it is therefore provided to provide a security module, the so-called trust management module (in the following abbreviated TMM). This module, too, is controlled by the multi-tasking kernel. The TMM module can assume different security-critical tasks in a protected environment, such as besides the pure SIM functionality a DRM authentication (DRM stands for digital rights management and relates to a checking system for checking a transmission of contents protected or to be protected). Moreover, other authorization mechanisms can be supported.

The TMM module can be formed physically as a hardware component. But it is also possible to provide the module or individual functionalities of the module as a software or as a computer program product, which run on a certain security processor e.g. on a secure ARM core.

At this point it shall be explicitly pointed out that all modules addressable by the central multi-tasking kernel can be realized as both hardware and software, which altogether increases the flexibility of the system.

An important advantage in connection with the security aspects of the TMM module is to be seen in that security functions can be flexibly reloaded. Moreover, it is possible to distinctly increase the functionality, which is supported by the TMM module according to the invention, in contrast to the prior art. With that the TMM module according to the invention operated by the multi-tasking kernel can offer distinctly more functionalities than it is known from e.g. Java card applets. Such functionalities are platform-dependent drivers for security protocols, such as IPSec or SSL/TLS or authorization systems for the digital rights management in connection with multimedia contents.

A substantial, advantageous aspect of the TMM module according to the invention is furthermore that it can perform active security checks itself. This is not the case with previous TPM modules (trusted platform modules, abbreviated TPM, is a security standard, which has been developed by the Trusted Computing Group; the modules of this standard in principle are realized as a system-on-chip). In contrast to the known TPM modules from the prior art, the TMM module according to the invention is not operated as a pure slave which only responses to inquiries of another instance, but the TMM module can also control actions independently. This feature of independent control, however, is not mandatory and only optional.

Altogether, by the operation of the chip card according to the invention with a TMM module an improved memory protection can be achieved. With the help of the operating system able to multi-tasking different security-critical tasks can be accommodated and with that realized in a security system, in particular in a specific chip card processor.

There are different embodiments, in which the TMM module can be realized on the mobile data carrier. It is possible to realize the TMM module adapted to be inserted or firmly wired, or it can be already integrated on the semiconductor. Moreover, it is possible to connect the module via different protocols, such as via the ISO7816 T=0 or T=1, via a USB interface or via an MMC interface or in general via the processor bus. Moreover, optionally, it is possible to provide an ICP-IP/stack on the layer2 protocol.

Further solutions of the problem mentioned at the outset are to be found in an operating system or in operating system components, in a mobile data carrier, in a microprocessor for being inserted into the mobile data carrier, in a computer program product and in a method for manufacturing or for maintaining the mobile data carrier according to the accompanying main claims. In principle, in this context it has to be pointed out that the description of the invention is based on a description of the method according to the invention. Advantageous embodiment, advantages and developments, which are described in the context with the method, apply accordingly to the other solutions of the invention, in particular to the mobile data carrier, the microprocessor and the computer program product. Accordingly, the above-mentioned solutions can also be developed into the method according to the invention with the help of the features of the subclaims.

The above described embodiments of the method according to the invention can also have the form of a computer program product, with a medium readable by a computer and with a computer program and pertinent program code means, the computer being prompted to carry out the above described method according to the invention after the computer program has been loaded.

An alternative solution for the task provides a storage medium, which is destined to store the above described computer-implemented method and readable by a computer.

A further solution of the problem is that the above described method is formed as an operating system or operating system component for a mobile data carrier, which is operated according to at least one feature of the method.

Additional advantageous embodiments can be found in the subclaims.

In the following detailed description of the figures there are explained embodiments with their features and further advantages with reference to the figure, not to be understood as restriction.

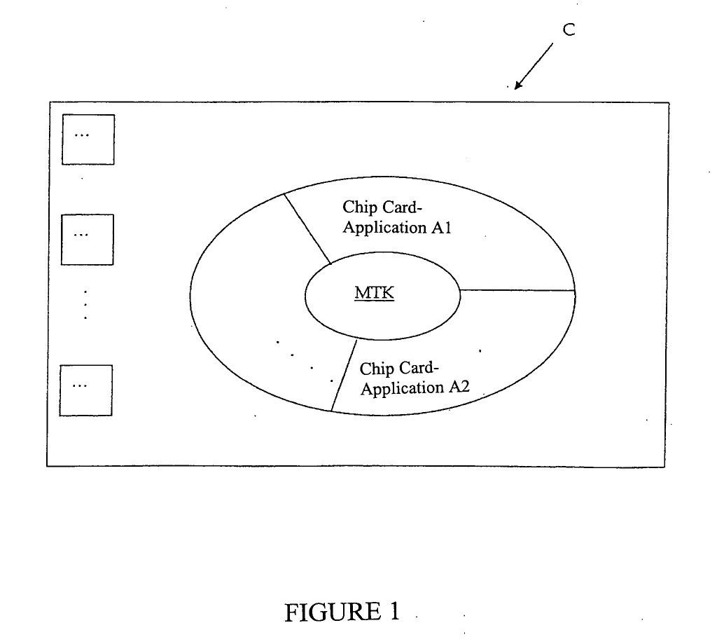

FIG. 1 shows a schematic, general representation of a multi-tasking kernel according to the invention, which controls the operation of the mobile data carrier according to an embodiment of the invention,

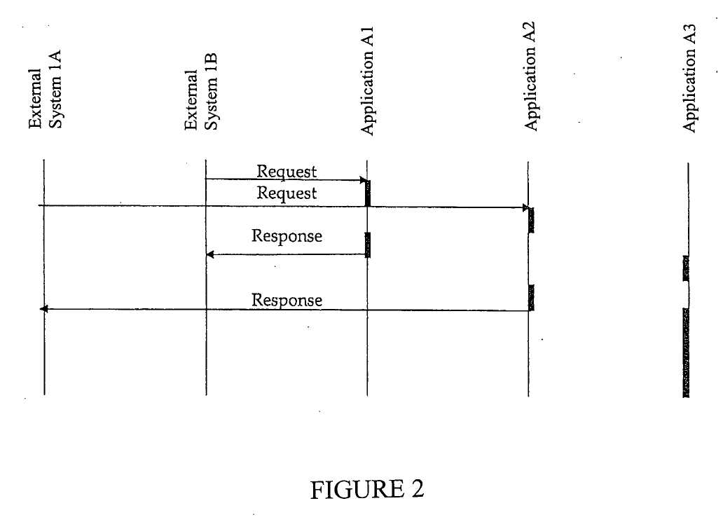

FIG. 2 shows a general representation of an activation of application programs by the multi-tasking kernel according to the invention according to a preferred embodiment and

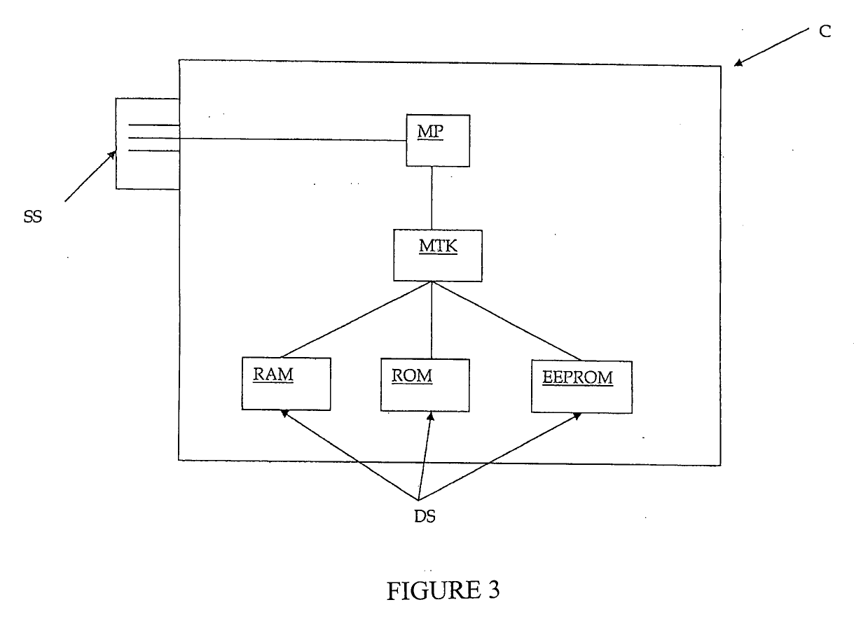

FIG. 3 shows a general representation of a possible structure of components of a data carrier according to the invention.

In the preferred embodiment and in the following a mobile data carrier is formed as a chip card C. The applications of chip card C, however, in principle are not restricted and can be in the field of payment transactions, finance, entrance control. Furthermore, it is possible, that chip card C is used for being inserted into further devices, e.g. mobile terminals such as telephones, and it is in particular a SIM card extended according to the invention.

In principle, chip card C itself and the application programs A running on it are controlled by an operating system. In previous chip card operating systems the program modules of the operating system usually were stored in a ROM memory unit (Read-Only-Memory ROM). So as to counter the disadvantages of a storage of operating system components exclusively in the ROM memory, it can be provided to solve individual operating system components in other memory areas, such as e.g. by a work area in EEPROM. The main tasks of a chip card operating system comprise the data exchange with the chip card, the sequential control of the instructions to be executed, the file management and the management and execution of security-technical functions and algorithms, such as cryptographic keys etc. Moreover, it is possible to provide in an area which is arranged in a way hierarchically above the application program instructions, an interpreter or a check program for executable files. The interpreter serves for executing the programs contained in these files or to interpret them. With this type of operating systems it is possible to reload program code even at a later point of time, in particular after the card has been issued.

As shown in FIG. 3 by way of example chip card C comprises an embedded microcontroller, which triggers, controls and monitors all activities of chip card C. The most important, typical components of a chip card microcontroller are the microprocessor MP, all interfaces SS of chip card C, in particular the address and data bus and the data memories DS which comprise all different types of memories, such as RAM, ROM and EEPROM. Interfaces SS of chip card C comprise all input/output interfaces for chip card C and thus concern the entire data transfer, which comes up with respect to chip card C.

According to the invention, in addition to these components a central control device MTK is provided, which in particular is formed by the multi-tasking kernel. In FIG. 3 the multi-tasking kernel MTK is shown as a separate component on chip card C. This is to illustrate that the multi-tasking kernel MTK—in contrast to the known chip card operating systems—is provided as an additional component. Normally, however, it is not provided as a separate, independent component but is integrated in other areas of the chip card as a separate module. In particular it will be provided as a modular, separate operating system component in addition to the previous operating system of chip card C.

Depending on the use of chip card C, chip card C comprises a plurality of application programs or services A, which are to run on the chip card.

Within the framework of this invention the terms “application program” A and “service” A are considered to be synonyms. An application program A comprises a plurality of instructions or processes, which must or can be executed at different points of time. Normally an application comprises a plurality of application programs A. But in principle it is also possible that a very simple application consists of only one single application program A.

With the help of the central multi-tasking kernel MTK there is created the possibility to offer a plurality of, in a way, “virtual” chip cards on one hardware platform of a chip card C. Here the individual virtual chip cards are strictly separated from each other, since all application programs and instructions are controlled via the central multi-tasking kernel MTK. Therefore, a one-way or mutual influence of active application programs or applications is reliably prevented by the multi-tasking kernel MTK.

The multi-tasking kernel MTK allocates to the application programs A appropriate quotas of computation time and resources according to a configurable scheduling-method. As shown by way of example in FIG. 1, all application programs A or chip card services A are in a data exchange with the multi-tasking kernel MTK and are controlled and executed by it. In FIG. 1 it is indicated that the scheduling of the multi-tasking kernel MTK is time-based. This is to be illustrated by the time-slice-like representation in FIG. 1. The multi-tasking kernel MTK monitors and controls the handling of the individual application programs at the time of execution. With the help of the configurable scheduling mechanism to one application program at a time is automatically provided a quota of computation time and resources, which can be used by the respective application program A. The execution time for each application program A thus is automatically limited in a configurable measure.

In the preferred embodiment of the invention the multi-tasking kernel MTK must carry out an analysis of the current system state with application programs A to be triggered respectively and thereupon must control the entire handling or operation of the chip card C, so that in view of the entirety of all instructions to be executed an optimized execution is effected. Here the optimization criteria are configurable: e.g. an optimization regarding time, system resources, memory space, electricity consumption etc.

Before the execution of a respective application program A the multi-tasking kernel MTK determines how much computation time is necessary for the execution and how much and/or which resources are required. If now a plurality of application programs A are to be executed, the multi-tasking kernel MTK can trigger, due to the analysis of the computation time and required resources of all application programs, an optimized handling of individual processes which are associated to the respective application programs A. When e.g. a first application program A₁ has the task to pass on data via a contactless interface to an external module and when e.g. a second application program A₂ has the task to receive data from a further external module via a contact-type interface, the multi-tasking kernel MTK can prompt a virtually parallel, which means simultaneous, activation of the two application programs A₁ and A₂, since the two application programs access different resources (in this case different interfaces SS). With that the sequential processing path of instructions of previous prior art systems can be parallelized and distributed to a plurality of synchronously running processes, so that altogether the performance can be increased.

By operating chip card C with the multi-tasking kernel MTK according to the invention it is possible to realize a plurality of concurrent threads, when no competing or conflicting accesses to the same resources are necessary. It can be provided, that the multi-tasking kernel MTK accesses a time-based scheduling, in case it detects a competing access from different application programs at the same time to the same resources. The time-based scheduling then provides, that the entirety of the processes to be executed of the two application programs A₁ and A₂ is controlled such that altogether (i.e. in view of the entirety of the two application programs A₁ and A₂) an optimized, in particular time-optimized, execution is permitted. With that it is e.g. possible to have prepared data of an application A₁ in the background, while another application A₂ e.g. communicates with an external system via interfaces SS.

In FIG. 2 it is schematically shown, how the multi-tasking kernel MTK activates different application programs A₁, A₂, A₃ in an optimized fashion.

The application programs A₁ and A₂ shown in FIG. 2 each are caused by external systems. This can be e.g. an inquiry regarding account turnover within the framework of a financial application. Central idea of the present invention is that the individual inquiries and instructions to be executed are no longer executed directly, but all are controlled via the central multi-tasking kernel MTK. On the basis of the scheduling-algorithm the multi-tasking kernel MTK activates individual processes of the application programs A₁, A₂ and A₃, . . . , Aᵢ in such a way that an optimized execution of the entirety of all application programs Aᵢ is permitted. This is shown in FIG. 2 by the application programs activated by the multi-tasking kernel MTK being marked with a thick, vertically extending line, while the respective processes or instructions of an application program A, which at that time are not active or were not activated by the multi-tasking kernel MTK, are marked with a thin, vertical line. With that it is apparent that the multi-tasking kernel MTK on request of the external system 1B at first activates the application program A₁ and thereupon an instruction cycle of the application program A₂, which has been caused by the external system 1A. Following that, a return to application program A₁ is effected, so as to thereupon starting application program A₃ and, subsequently, terminating application program A₂. Following the termination of application program A₂ the remaining instructions of application program A₃ are executed. Altogether, in this way a time-optimized scheduling of the entirety of the application programs Aᵢ is possible.

A central aspect of the present invention lies in improved security precautions, in particular in an improved memory protection. In this case it is provided, that in at least one application program A all security-relevant instructions or processes, which are necessary within the framework of the operation of chip card C, are combined and integrated. This application program A or this module is referred to as TMM module (trust management modules). I.e. in this module all security-relevant functions and instructions are combined. It is possible to flexibly reload further security functions via certain protocols.

According to the invention the content of the TMM module can be flexibly configured. With that it is possible, depending on the application, to activate and/or to deactivate different security mechanisms, to achieve an optimal security-technical cover for the chip card C for every case of application. According to the invention the TMM module is adapted such that it can also actively perform security checks and thus is not—such as in the prior art—operated as a pure dependent process.

A further, substantial advantage of the solution according to the invention is that the security-technical processes, which are integrated in the TMM module, can be included in an optimized way in the sequence of operations or in the entire operation of the chip card C. What is behind that is that certain security-technical checks only make sense at a certain point of time in the sequence of system operations. E.g. an authentication measure is expedient only before the beginning of a transaction, while further security technical measures can also be carried out at a later point of time. The optimal, in particular time-optimal, control of all processes on the chip card C is checked and monitored by the multi-tasking kernel MTK.

For the solution according to the invention it is also possible that specific security mechanisms, which for example are to be used only in a certain application, with the help of the flexibly configurable TMM module can be used during the operation of the chip card C. In contrast to the prior art method an adaptation regarding security-technical measures to a certain type of application was not possible until now. This disadvantage is completely eliminated with the solution according to the invention.

The solution according to the invention, advantageously, is independent of the respective platform of the chip card C and in particular independent of whether a virtual machine is used or not or whether the virtual machine is realized in an off-card or on-card fashion.

At this point it should again be pointed out that the above detailed description of the figures in the context with the solution according to the invention has been described by the method. Advantageous developments, alternatives, advantages and features, which have been described in connection with the method, must also be read in view of the other solutions of the problem and thus in particular are applicable to the mobile data carrier, the microprocessor, the computer program product and the method for manufacturing and/or for maintaining the mobile data carrier. The above-mentioned modules, components and units of the described method can be both already integrated in a unit ready for sale, but they can also be subsequently integrated as an independent separate product, without any further measures becoming necessary to be taken at the existing product.

The embodiments described in this detailed description of the figures are to represent only examples and can be modified by the person skilled in the art in many different ways, without the scope of the invention being left. For a person skilled in the art working in the relevant field it is in particular obvious, that the invention can also be realized as a heterogeneous system and distributed partially or completely among software and/or hardware and a plurality of physical products—here in particular computer program products.

1-15. (canceled)

16. A method for operating a mobile data carrier (C) which is provided with following resources: a microprocessor (MP), a data memory (DS), interfaces (SS) for a data exchange between microprocessor (MP) and either or both data memory (DS) and further modules which are associated with the mobile data carrier (C), comprising executing different application programs (A) on the mobile data carrier (C) at the same time, by operating the mobile data carrier (C) while using a central control unit (MTK) to monitor the operation of the mobile data carrier (C), said central control unit (MTK) allocating to one application program (A) at a time resources according to either or both a scheduling mechanism and the data exchange being controlled.

17. The method according to claim 16, including forming in the control unit (MTK) a hardware-supported protective mechanism for the data memory (DS).

18. The method according to claim 16, wherein the scheduling mechanism is configurable.

19. The method according to claim 16, including controlling the operation of the mobile data carrier (C) using the control unit (MTK) in such a way that the data exchange between either or both different applications and between different application programs (A) is either or both controlled and executed exclusively via the control unit (MTK).

20. The method according to claim 16, including controlling the operation of the mobile data carrier (C) using the control unit (MTK) in such a way that a parallel or simultaneous communication with external modules is effected via a plurality of equal or different hardware interfaces (SS).

21. The method according to claim 16, wherein the mobile data carrier (C) has a plurality of operation modes and at least so much rights are granted to the operation mode with which the control unit is operated as are granted to the remaining operation modes.

22. The method according to claim 16, wherein the scheduling mechanism automatically limits an execution time for an application program (A), by checking a consumption of computation time and allocating computation time to the respective application programs (A).

23. The method according to claim 16, wherein the configurable mechanism takes into account rights which can be granted to an application program (A) and which can be passed on to subordinated sub-application programs.

24. The method according to claim 16, wherein each application program (A) either or both individually and together with other application programs has a protected address space in the data memory (DS).

25. The method according to claim 16, including using the central control device (MTK) to either or both control and monitor all security-relevant functions.

26. A mobile data carrier (C), on which different application programs (A) can be executed, comprising:
a microprocessor (MP),
a data memory (DS),
interfaces (SS) for a data exchange between microprocessor (MP) and either or both data memory (DS) and further modules, which are associated with the mobile data carrier (C), wherein the mobile data carrier (C) comprises a central control unit (MTK) having a scheduler, the control unit (MTK) either or both controlling and monitoring the operation of the mobile data carrier (C) in such a way that activation of a plurality of application programs (A) at the same time is enabled by the scheduler according to a configurable mechanism allocating resources for either or both one application program at a time and controlling the data exchange.

27. A microprocessor (MP) for being inserted into a mobile data carrier (C), on which different application programs (A) can be executed, the microprocessor (MP) comprising:
a data memory (DS),
interfaces (SS) for a data exchange between the microprocessor and either or both data memory and further modules,
the microprocessor (MP) being associated with central control unit (MTK) having a scheduler, and
the control unit (MTK) either or both controlling and monitoring the operation of the mobile data carrier (C) in such a way that activation of a plurality of application programs (A) at the same time is enabled by the scheduler according to a configurable mechanism allocating resources for either or both one application program at a time and controlling the data exchange.

28. A computer program product, which is loadable directly into a data memory (DS) of a programmable mobile data carrier (C) or into a control device associated with the mobile data carrier (C), said program including code enabling execution of all or selected steps of the method of claim 1 when the program is executed in either the mobile data carrier (C) or in the control device.

29. The computer program product according to claim 27, wherein the computer program product is formed as an operating system or operating system component.

30. A method for either or both manufacturing and maintaining a mobile data carrier (C) which is operated with a method according to claim 1, wherein components of the mobile data carrier are replaceable by other components even after the mobile data carrier (C) has been issued.
